(19) United States
(12) Patent Application Publication
(10) Pub. No.: US 2022/0390602 A1
(43) Pub. Date: Dec. 8, 2022

(54) DEVICE TO DETERMINE ANGLE AND DISTANCE FOR CONDUIT INSTALLATION AND SYSTEM THEREOF

(71) Applicant: Theophilus Burroughs, Washington, DC (US)

(72) Inventor: Theophilus Burroughs, Washington, DC (US)

(21) Appl. No.: 17/339,932

(22) Filed: Jun. 4, 2021

(51) Int. Cl. G01S 17/06; G01S 7/48; G01B 11/26; G01S 7/51

(52) U.S. Cl. CPC G01S 17/06; G01S 7/4808; G01B 11/26; G01S 7/51

(57) ABSTRACT

A position determination device, including a main body, a first laser emitter disposed on at least a portion of the main body to emit a first laser beam pointing in a first direction, a second laser emitter hingedly disposed on at least a portion of the main body to emit a second laser beam pointing in the first direction, such that the first laser emitter and the second laser emitter determine at least one of a size of a conduit, an angle to install the conduit, a distance of the first laser emitter to a wall, and a distance of the second laser emitter to the wall, and a conduit attachment unit removably connected to at least a portion of the main body to connect the main body to the conduit.

### BACKGROUND

### 1. Field

The present general inventive concept relates generally to conduit installation, and particularly, to a device and system to determine angle and distance for conduit installation.

### 2. Description of the Related Art

Conduits, such as electrical conduits, are metal and/or plastic pipes used to run electrical wiring. Conduits may be rigid or flexible, but both types of conduits provide protection for electrical wires that would otherwise be exposed to potential damage from external influence. Typically, the electrical wiring is forced through the conduit during installation, whereas a cable contains multiple wires within a protective sheath.

Regardless of where the conduits are placed, it requires meticulous planning, due to a change in grade of land and/or building surfaces. In other words, changing directions of where the conduits are position are a constant consideration.

Currently, a pipe laser is a type of electronic level that can provide accurate grade measurements without using stakes and/or lines to supplement positioning. Moreover, the pipe laser uses a laser beam that is easily visible and can identify lengths and/or targets at long range.

However, the pipe laser has a fixed position. Thus, the pipe laser can draw the laser beam on a surface, such as a wall, but only on a single plane. Based on the aforementioned change in grade of land, the pipe laser having a fixed position is problematic because it would not be able to accommodate changes in position without also adjusting a position of the pipe laser itself.

Therefore, there is a need for a device and system to determine an angle and distance for conduit installation that adjusts a position of a laser. Also, there is a need for a system that can be easily connected to the conduit without relying on external tools to complete the connection.

### SUMMARY

The present general inventive concept provides a device and system to determine angle and distance for conduit installation.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a position determination device, including a main body, a first laser emitter disposed on at least a portion of the main body to emit a first laser beam pointing in a first direction, a second laser emitter hingedly disposed on at least a portion of the main body to emit a second laser beam pointing in the first direction, such that the first laser emitter and the second laser emitter determine at least one of a size of a conduit, an angle to install the conduit, a distance of the first laser emitter to a wall, and a distance of the second laser emitter to the wall, and a conduit attachment unit removably connected to at least a portion of the main body to connect the main body to the conduit.

The first laser emitter may be fixed pointing in the first direction.

The second laser emitter may move from pointing in the first direction to pointing at least partially toward a second direction different from the first direction, and moves from pointing in the second direction to pointing in the first direction.

The second laser emitter may emit the second laser beam on a same point as the first laser emitter while the second laser emitter is pointing in the first direction.

The conduit attachment unit may include a connecting body, a conduit connecting surface disposed on at least a portion of the connecting body to removably connect the main body to the conduit, a first connecting ridge disposed on at least a portion of the connecting body to removably connect to at least a portion of the main body, and a second connecting ridge disposed on at least a portion of the connecting body to removably connect to at least a portion of the main body.

The conduit connecting surface may be magnetically connected to the conduit.

The conduit connecting surface may have a concave surface that corresponds to a convex surface of the conduit.

The main body may include a groove longitudinally disposed on at least a portion of the main body to receive the connecting body therein, a first connecting edge disposed on at least a portion of the main body to connect to the first connecting ridge, and a second connecting edge disposed on at least a portion of the main body to connect to the second connecting ridge.

The position determination device may further include a display unit disposed on at least a portion of the main body to display a digital readout of at least one number corresponding to at least one of the size of the conduit, the angle to install the conduit, the distance of the first laser emitter to the wall, and the distance of the second laser emitter to the wall.

The position determination device may further include an input unit disposed on at least a portion of the main body to move the second laser emitter from pointing in the first direction to pointing at least partially toward a second direction in response to the input unit receiving a first position input, and move the second laser emitter from pointing in the second direction to pointing in the first direction in response to the input unit receiving a second position input.

The foregoing and/or other features and utilities of the present general inventive concept may also be achieved by providing a system to determine an angle and distance for installation of a conduit, the system including a position determination device removably connected to the conduit to emit a first laser beam pointing in a first direction and a second laser beam pointing in the first direction, and a mobile device running a program thereon and connected to the position determination device to move the second laser beam from pointing in the first direction to pointing at least partially toward a second direction different from the first direction, and display a digital readout of at least one number corresponding to at least one of a size of the conduit based on the position of the first laser beam and the second laser beam, an angle to install the conduit, a distance of the first laser beam to a wall, and a distance of the second laser beam to the wall.

The position determination device may include a main body, a first laser emitter disposed on at least a portion of the main body to emit a first laser beam pointing in the first direction, and a second laser emitter hingedly disposed on at least a portion of the main body to emit a second laser beam pointing in the first direction.

The second laser emitter may move from pointing in the first direction to pointing at least partially toward the second direction in response to the mobile device receiving a first position input, and moves from pointing in the second direction to pointing in the first direction in response to the mobile device receiving a second position input.

The mobile device may automatically move the second laser beam based on at least one of the size of the conduit based on the position of the first laser beam and the second laser beam, the angle to install the conduit, the distance of the first laser beam to the wall, and the distance of the second laser beam to the wall.

The foregoing and/or other features and utilities of the present general inventive concept may also be achieved by providing a position determination device, including a main body, a first light emitter disposed on the main body to emit a first beam of light in at least a first direction, a second light emitter moveably disposed on the main body to emit a second beam of light in at least the first direction, and a processor to perform a calculation based on information received from at least one of the first light emitter and the second light emitter to output a numeric value corresponding to at least one of a size of a conduit, an angle required to install the conduit, a distance of the first laser emitter to a wall, a distance of the second laser emitter to the wall, and an angle between the first laser beam and the second laser beam.

The position determination device may further include a display unit to display the output calculated by the processor.

The position determination device may further include a conduit attachment unit removably connected to at least a portion of the main body to connect the main body to the conduit.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates an isometric top view of a position determination device with a second laser emitter in a first direction, according to an exemplary embodiment of the present general inventive concept;

FIG. 1B illustrates an isometric top view of the position determination device with the second laser emitter in the first direction, according to an exemplary embodiment of the present general inventive concept;

FIG. 2 illustrates an isometric top view of the position determination device with the second laser emitter in a second direction, according to an exemplary embodiment of the present general inventive concept;

FIG. 3A illustrates an isometric top view of a conduit attachment unit, according to an exemplary embodiment of the present general inventive concept;

FIG. 3B illustrates an isometric top view of a conduit attachment unit, according to another exemplary embodiment of the present general inventive concept;

FIG. 3C illustrates an isometric top view of a conduit attachment unit, according to another exemplary embodiment of the present general inventive concept;

FIG. 4 illustrates an isometric top view of the position determination device connected to the conduit attachment unit, according to an exemplary embodiment of the present general inventive concept;

FIG. 5A illustrates an elevational side view of the position determination device as disposed on a conduit, according to an exemplary embodiment of the present general inventive concept;

FIG. 5B illustrates an isometric side view of the position determination device as disposed on a bottom portion of a conduit, according to an exemplary embodiment of the present general inventive concept;

FIG. 6 illustrates an isometric top view of the position determination device as disposed on the conduit, according to an exemplary embodiment of the present general inventive concept;

FIG. 7A illustrates a rear perspective view of a system to determine angle and distance for conduit installation, according to another exemplary embodiment of the present general inventive concept; and

FIG. 7B illustrates a side perspective view of the system to determine angle and distance for conduit installation, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

System 1
Position Determination Device 100
Main Body 110
Cross Section 111
Laser Channel 112
Groove 113
First Connecting Edge 114
Second Connecting Edge 115
First Laser Emitter 120
First Portion 121
First Angled End 121a
Second Angled End 121b
Second Portion 122
Angled End 122a
Second Laser Emitter 130
Hinge Assembly 140
First Hinge 141
First Arm 142
Second Hinge 143
Second Arm 144
Display Unit 150
Processing Unit 155
Input Unit 160
First Laser Emitter Button 161
Second Laser Emitter Button 162
Power Button 163
Display Control Unit 170
Switch 171
Setting Indicators 172
Conduit Attachment Unit 180
Connecting Body 181
Conduit Connecting Surface 182
First Connecting Ridge 183
Second Connecting Ridge 184
Battery Compartment 190
Position Determination Device 200
Main Body 210
Cross Section 211
Laser Channel 212
Groove 213
First Connecting Edge 214
Second Connecting Edge 215
First Laser Emitter 220
First Portion 221
First Angled End 221a
Second Angled End 221b
Second Portion 222
Angled End 222a
Second Laser Emitter 230
Hinge Assembly 240
First Hinge 241
First Arm 242
Second Hinge 243
Second Arm 244
Input Unit 250
First Laser Emitter Button 251
Second Laser Emitter Button 252
Power Button 253
Processing Unit 255
Conduit Attachment Unit 280
Connecting Body 281
Conduit Connecting Surface 282
First Connecting Ridge 283
Second Connecting Ridge 284
Battery Compartment 290
Mobile Device 300
Input Unit 310
Display Unit 320
Processing Unit 330
Communication Unit 340
Storage Unit 350
Conduit Attachment Unit 380
Connecting Body 381
Conduit Connecting Surface 382
First Connecting Ridge 383
Second Connecting Ridge 384

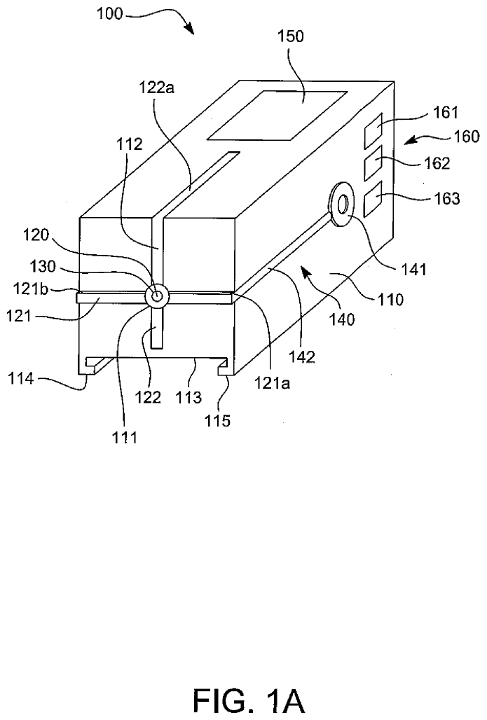

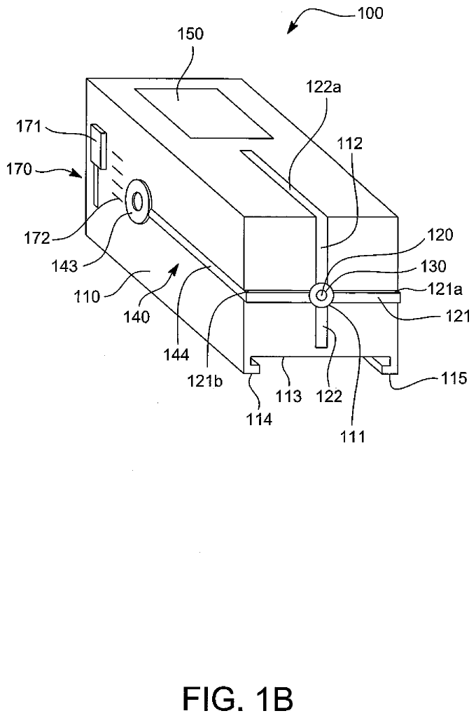

FIG. 1A illustrates an isometric top view of a position determination device 100 with a second laser emitter 130 in a first direction, according to an exemplary embodiment of the present general inventive concept.

FIG. 1B illustrates an isometric top view of the position determination device 100 with the second laser emitter 130 in the first direction, according to an exemplary embodiment of the present general inventive concept.

The position determination device 100 may be constructed from at least one of metal, plastic, wood, glass, and rubber, etc., but is not limited thereto.

Referring to FIGS. 1A and 1B, the position determination device 100 may include a main body 110, a first laser emitter 120, a second laser emitter 130, a hinge assembly 140, a display unit 150, a processing unit 155, an input unit 160, a display control unit 170, a conduit attachment unit 180, and a battery compartment 190, but is not limited thereto.

Referring again to FIGS. 1A and 1B, the main body 110 is illustrated to have a rectangular prism shape. However, the main body 110 may be rectangular, circular, spherical, conical, triangular, pentagonal, hexagonal, heptagonal, octagonal, or any other shape known to one of ordinary skill in the art, but is not limited thereto.

The main body 110 may include a cross section 111, a laser channel 112, a groove 113, a first connecting edge 114, and a second connecting edge 115, but is not limited thereto.

The cross section 111 may be disposed on at least a portion of a center of a first side of the main body 110.

Referring again to FIGS. 1A and 1B, the laser channel 112 may be longitudinally disposed away from the cross section 111 with respect to the cross section 111. Moreover, the laser channel 112 may extend along at least a portion of the first side and/or a second side of the main body 110, such that the second side of the main body 111 may be perpendicularly disposed away from a first edge of the first side with respect to a direction.

The groove 113 may be longitudinally disposed on at least a portion of a third side of the main body 110, such that the third side of the main body 110 may be perpendicularly disposed away from a second edge of the first side of the main body 110 with respect to the direction. As such, the second side of the main body 110 may be parallel to the third side. Also, the groove 113 may extend a full length of the third side of the main body 110.

The first connecting edge 114 may be disposed on at least a portion of the third side of the main body 110. Additionally, the first connecting edge 114 may extend and/or protrude away from the third side of the main body 110 in an L-shape and/or a hook shape toward a center of the groove 113.

The second connecting edge 115 may be disposed on at least a portion of the third side of the main body 110. Additionally, the second connecting edge 115 may extend and/or protrude away from the third side of the main body 110 in an L-shape and/or a hook shape toward the center of the groove 113. Accordingly, the second connecting edge 115 may point toward the first connecting edge 114 and vice versa.

The first laser emitter 120 may include a first portion 121 and a second portion 122, but is not limited thereto.

The first laser emitter 120 may be a line laser, a spot laser, a combination laser, a rotary laser, and a laser detector, but is not limited thereto.

The first laser emitter 120 may also be called a first light emitter 120, and is not limited to emitting laser beams, but may also emit various other types of light, such as LEDs, incandescent light, etc., but is not limited thereto.

The first laser emitter 120 may be disposed on at least a portion of the cross section 111 of the main body 110. The first laser emitter 120 may emit a first laser beam 20 toward a surface of a wall 10. Moreover, the first laser emitter 120 may emit the first laser beam 20 as a first line and/or a first point on the wall 10. The first laser emitter 120 may remain in a fixed position with respect to the main body 110.

Furthermore, the first laser emitter 120 may include crosshairs formed by an intersection of the first portion 121 and/or the second portion 122. Referring again to FIGS. 1A and 1B, the first portion 121 may be longitudinally disposed along the center of the first side of the main body 110. The second portion 122 may be perpendicularly disposed at the center of the first side of the main body 110 with respect to a direction. Accordingly, the first portion 121 and/or the second portion 122 may form the crosshairs.

In addition, the crosshair shape of the first laser emitter 120 may be included to act as a level, stabilizer, and/or balance, in order to allow a user to verify that angles between pipes, walls, ceilings, and floors are proper, perpendicular, parallel, or straight. In other words, the crosshair shape may perform a function similar to a bubble level, to ensure that an object is level with regard to another object.

The first portion 121 may include a first angled end 121a and a second angled end 121b, but is not limited thereto.

The first angled end 121a may be disposed on at least a portion of a fourth side of the main body 110. Moreover, the first angled end 121a may be perpendicularly disposed away from a remainder of the first portion 121 disposed on the first side of the main body 110 with respect to a first direction. As such, the first angled end 121a may allow the first laser emitter 120 to emit the first laser beam on the wall 10 and a first other surface angularly disposed away from the wall 10, such that the first other surface is disposed a distance away from the first laser emitter 120.

Similarly, the second angled end 121b may be disposed on at least a portion of a fifth side of the main body 110 opposite with respect to the fourth side. Moreover, the second angled end 121b may be perpendicularly disposed away from the remainder of the first portion 121 disposed on the first side of the main body 110 with respect to the first direction. As such, the second angled end 121b may allow the first laser emitter 120 to emit the first laser beam on the wall 10 and/or a second other surface angularly disposed away from the wall 10, such that the second other surface is disposed another distance away from the first laser emitter 120.

The second portion 122 may include an angled end 122a, but is not limited thereto.

The angled end 122a may be disposed on at least a portion of a sixth side of the main body 110. Moreover, the angled end 122a may be perpendicularly disposed away from the remainder of the second portion 121 disposed on the first side of the main body 110 with respect to the first direction. As such, the angled end 122a may allow the first laser emitter 120 to emit the first laser beam on the wall 10 and/or a third other surface angularly disposed away from the wall 10, such that the third other surface is disposed another distance away from the first laser emitter 120.

Accordingly, the first angled end 121a, the second angled end 121b, and/or the angled end 122a may allow the first laser emitter 120 to angularly (e.g., perpendicularly) emit the first laser beam 20 on different surfaces aside from the wall 10 directly in front of the first laser emitter 120. As such, for example, the first laser emitter 120 may emit the first laser beam 20 on the wall 10, a ceiling, and/or two side walls.

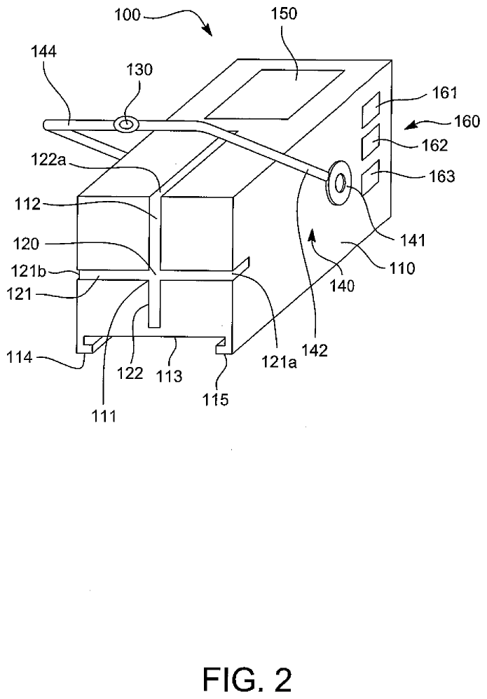

FIG. 2 illustrates an isometric top view of the position determination device 100 with the second laser emitter 130 in at least one second direction, according to an exemplary embodiment of the present general inventive concept.

The second laser emitter 130 may include a line laser, a spot laser, a combination laser, a rotary laser, and a laser detector, but is not limited thereto.

The second laser emitter 130 may also be called a second light emitter 120, and is not limited to emitting laser beams, but may also emit various other types of light, such as LEDs, incandescent light, etc., but is not limited thereto.

The second laser emitter 130 may be movably disposed (e.g., hingedly disposed, reciprocally disposed, etc.) on at least a portion of the main body 110. More specifically, the second laser emitter 130 may move (i.e., pivot and/or rotate) from pointing in a first direction that is parallel with respect to the first laser emitter 120 to pointing at least partially toward at least one second direction different from the first direction. Conversely, the second laser emitter 130 may move from pointing in the at least one second direction to pointing in the first direction. As such, the second laser emitter 130 may originate by pointing at the first point, which is identical to the first laser emitter 120, and subsequently, move to another position, such that the second laser emitter 130 may be angularly disposed at a different angle with respect to the first laser emitter 120 and emit a second laser beam 30 toward the surface of the wall 10 as a second line and/or a second point 31 on the wall 10. Alternatively, the second point 31 may be referred to as a laser point 31. Accordingly, the laser point 31 may identify a target position for the conduit 50 and/or another conduit 50.

Additionally, the second laser beam 30 may be visible and/or invisible. In other words, a visibility of the second laser beam 30 may be adjusted based on a preference of a user, such as using the input unit 160. However, the laser point 31 may be visible on the wall 10 while the second laser beam 30 is invisible.

Furthermore, the second laser emitter 130 may move up to a second position at a ninety degree angle with respect to the first point.

Also, it is important to note that although the first laser emitter 120 is described as being fixed, the first laser emitter 120 may be hingedly disposed on the main body 110 similar to the second laser emitter 130. As such, the first laser emitter 120 may move to different positions similar to the second laser emitter 130 as described above.

The hinge assembly 140 may include a first hinge 141, a first arm 142, a second hinge 143, and a second arm 143, but is not limited thereto.

The first hinge 141 may be disposed on at least a portion of the fourth side of the main body 110.

The first arm 142 may be disposed on at least a portion of the first hinge 141 and connected to the second laser emitter 130.

The second hinge 143 may be disposed on at least a portion of the fifth side of the main body 110 opposite with respect to the fourth side.

The second arm 143 may be disposed on at least a portion of the second hinge 143 and connected to the second laser emitter 130. As such, the second laser emitter 130 may move in response to movement of the first hinge 141, the first arm 142, the second hinge 143, and/or the second arm 143. It is important to note that the first hinge 141, the first arm 142, the second hinge 143, and/or the second arm 143 may move simultaneously. Also, the first arm 142 and/or the second arm 143 may project the second laser emitter 130 a distance away from any surface of the main body 110.

Additionally, although the figures in the present application depict the first laser emitter 120 as being stationary, alternatively, the first laser emitter 120 may be movable, rotatable, hinged, or mobile in any other manner. Furthermore, the present general inventive concept may include two or more first laser emitters 120 and/or two or more second laser emitters 130.

The display unit 150 may include a plasma screen, an LCD screen, a light emitting diode (LED) screen, an organic LED (OLED) screen, a computer monitor, a hologram output unit, a sound outputting unit, or any other type of device that visually or aurally displays data.

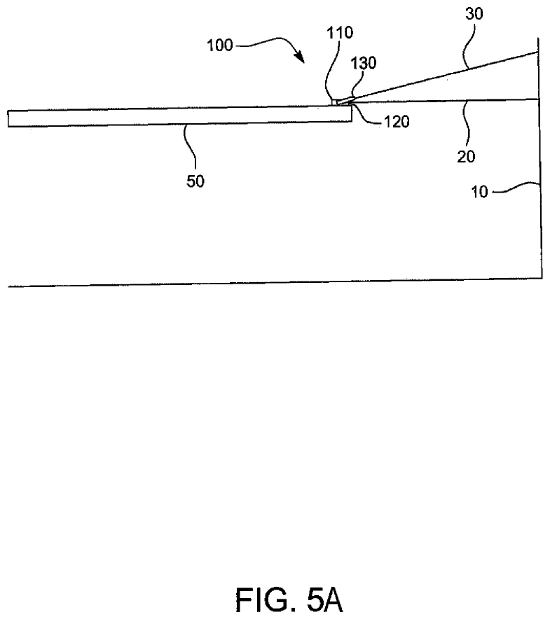

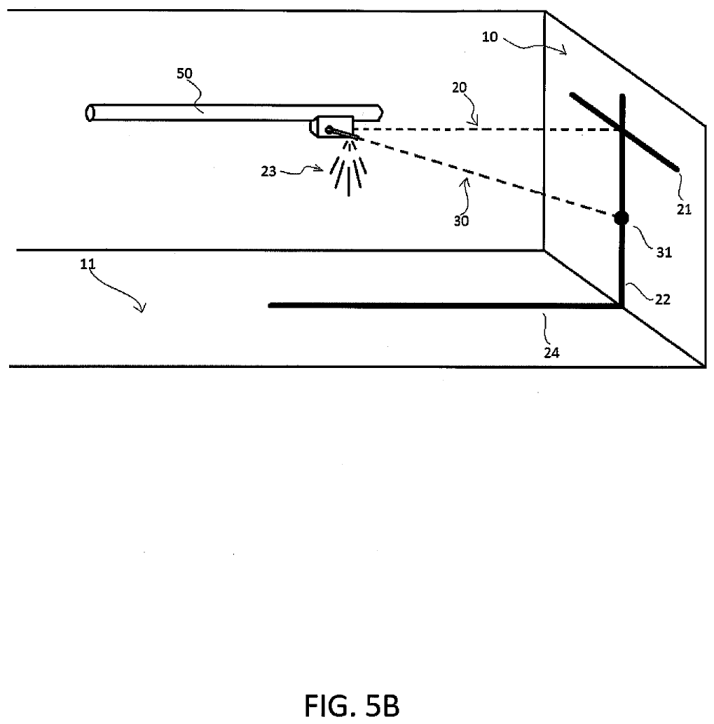

The display unit 150 may be disposed on at least a portion of the main body 110. Moreover, the display unit 150 may provide a digital readout of at least one number corresponding to conduit installation information. More specifically, the display unit 150 may display the digital readout corresponding to a size of a conduit 50 (as seen in FIG. 5) based on a position of the first laser beam 20 and/or the second laser beam 30, an angle at which the conduit 50 and/or the another conduit 50 needs to be positioned (e.g., angled, bent) with respect to the conduit 50, a distance of the first laser emitter 120 to the wall 10, and/or a distance of the second laser emitter 130 to the wall 10. As such, the display unit 150 may display the conduit installation information to facilitate installation of the conduit 50.

The conduit 50 may be a pipe that allows electrical wires to be installed and/or threaded therethrough, but is not limited thereto, and may include any type of a pipe, including plumbing pipes, metal pipes, etc.

The processing unit 155 (or central processing unit, CPU) may include electronic circuitry to carry out instructions of a computer program by performing basic arithmetic, logical, control and input/output (I/O) operations specified by the instructions. The processing unit 155 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 155 may also include a microprocessor and a microcontroller.

The processing unit 155 may further include a storage unit (e.g., a random access memory (RAM), a read-only memory (ROM), a hard disk, a flash drive, a database connected to the Internet, cloud-based storage, Internet-based storage, or any other type of storage unit), but is not limited thereto.

The processing unit 155 may be disposed within at least a portion of the main body 110. The processing unit 155 may run software, a software application, and/or a mobile application. For ease of description, the software, and/or mobile and/or the software application will be hereinafter referred to as calculation software or a calculation application. The processing unit 155 executing the calculation software may calculate the size of pipe based on the position of the first laser beam 20 and/or the second laser beam 30, the angle at which the conduit 50 and/or the another conduit 50 needs to be positioned with respect to the conduit 50, the distance of the first laser emitter 120 to the wall 10, and/or the distance of the second laser emitter 130 to the wall 10. Moreover, the processing unit 155 executing the calculation software may analyze the distance and/or the angle based on mathematical formulas. For example, the processing unit 155 may analyze a triangular shape and/or angle based on at least one position of the first laser emitter 120 and/or the second laser emitter 130 using the law of sines, the law of cosines, Pythagorean theorem, sines, cosines, tangents, secants, and/or cosecants.

The display unit 150 may display results of calculations or analyses performed by the calculation software, and/or may display any of distance measurements, lengths, sizes of pipes, and/or angles between pipes required and/or requested by the user.

The input unit 160 may include a first laser emitter button 161, a second laser emitter button 162, and a power button 163, but is not limited thereto.

Furthermore, the input unit 160 may include a communication module, such as a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The input unit 160 may be disposed on at least a portion of the fourth side of the main body 110.

Referring again to FIGS. 1A through 2, the first laser emitter button 161, the second laser emitter button 162, and/or the power button 163 are each illustrated to be a button. However, the first laser emitter button 161, the second laser emitter button 162, and/or the power button 163 may be a switch, a lever, a knob, and/or a dial, but is not limited thereto.

The first laser emitter 120 may turn on the first laser beam 20 in response to depressing the first laser emitter button 161 a first time. Conversely, the first laser emitter 120 may turn off the first laser beam 20 in response to depressing the first laser emitter button 161 a second time.

The second laser emitter 130 may turn on the second laser beam 30 in response to depressing the second laser emitter button 162 a first time. Conversely, the second laser emitter 130 may turn off the second laser beam 30 in response to depressing the second laser emitter button 162 a second time. Furthermore, the second laser emitter 130 may move in response to depressing the second laser emitter button 162 for at least one predetermined period of time. For example, the second laser emitter 130 may move to a first predetermined position (e.g., the original position) in response to depressing the second laser emitter button 162 for five seconds, move to a second predetermined position (e.g., ten degrees away from the original position and/or the first laser emitter 120 position) in response to depressing the second laser emitter button 162 for ten seconds, and move to a third predetermined position (e.g., ninety degrees away from the original position and/or the first laser emitter position 120 as in FIG. 2) in response to depressing the second laser emitter button 162 for fifteen seconds. Also, the second laser emitter 130 may move anywhere in between the aforementioned positions after stopping depressing the second laser emitter button 130 in between movement.

The first laser emitter 120, the second laser emitter 130, and/or the display unit 150 may turn on in response to depressing the power button 163 a first time. Conversely, the first laser emitter 120, the second laser emitter 130, and/or the display unit 150 may turn off in response to depressing the power button 163 a second time.

The display control unit 170 may include a switch 171 and plurality of setting indicators 172, but is not limited thereto.

The display control unit 170 may be disposed on at least a portion of the fifth side of the main body 110.

Referring again to FIG. 1B, the switch 171 is illustrated to be a switch. However, the switch 171 may be a button, a lever, a knob, and/or a dial, but is not limited thereto.

The switch 171 may be movably (i.e. slidably) disposed on at least a portion of the main body 110. The switch 171 may move from a first position to at least a partially toward a second position in response to an application of force thereto. Conversely, the switch 171 may move from the second position to the first position. As such, the switch 171 may select the digital readout of the at least one number corresponding to conduit installation information on the display unit 150.

Each of the plurality of setting indicators 172 may correspond to a setting of the display unit 150 based on a position of the switch 171. Moreover, the plurality of setting indicators 172 may correspond to the size of pipe based on the position of the first laser beam 20 and/or the second laser beam 30, the angle at which the conduit 50 and/or the another conduit 50 needs to be positioned with respect to the conduit 50, the distance of the first laser emitter 120 to the wall 10, and/or the distance of the second laser emitter 130 to the wall 10. Accordingly, the switch 171 may select information displayed on the display unit 150.

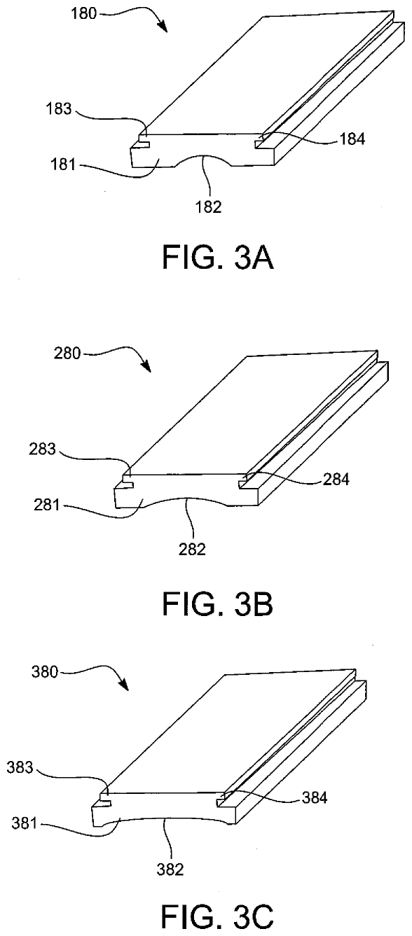

FIG. 3A illustrates an isometric top view of a conduit attachment unit 180, according to an exemplary embodiment of the present general inventive concept.

FIG. 3B illustrates an isometric top view of a conduit attachment unit 280, according to another exemplary embodiment of the present general inventive concept.

FIG. 3C illustrates an isometric top view of a conduit attachment unit 380, according to another exemplary embodiment of the present general inventive concept.

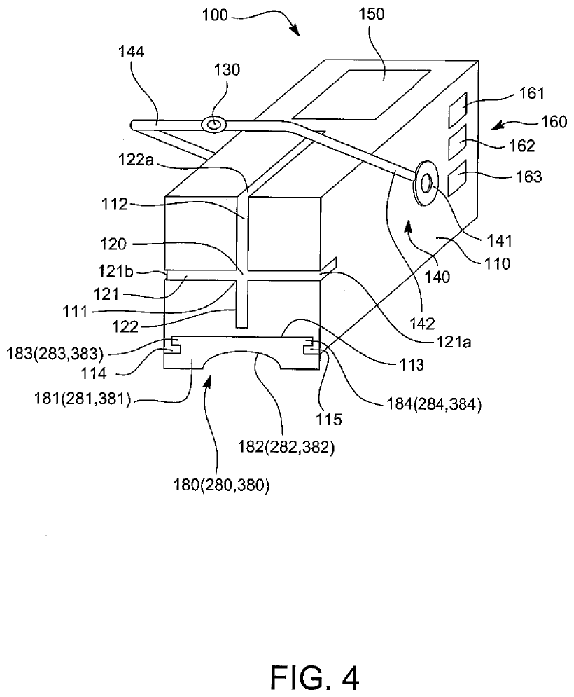

FIG. 4 illustrates an isometric top view of the position determination device 100 connected to the conduit attachment unit 180, according to an exemplary embodiment of the present general inventive concept.

FIG. 5A illustrates an elevational side view of the position determination device 100 as disposed on a top portion of a conduit 50, according to an exemplary embodiment of the present general inventive concept.

FIG. 5B illustrates an elevational side view of the position determination device 100 as disposed on a bottom portion of a conduit 50, according to an exemplary embodiment of the present general inventive concept.

The conduit attachment unit 180 may include a connecting body 181, a conduit connecting surface 182, a first connecting ridge 183, and a second connecting ridge 184, but is not limited thereto.

The conduit attachment unit 180 may be a magnet, but is not limited thereto.

The connecting body 181 may be removably connected to at least a portion of the main body 110. Moreover, the connecting body 181 may be connected to the main body 110 without using tools and/or external fasteners (e.g., screw, nail, bolt, washer, nut, etc.). For example, referring to FIG. 4, the connecting body 181 may connect to the groove 113, such that the first connecting ridge 183 may be inserted into the first connecting edge 114, and the second connecting ridge 184 may be inserted into the second connecting edge 115. In other words, the groove 113 may receive the connecting body 181 therein.

The connecting body 181 and/or the conduit connecting surface 182 may include a magnet, a rope, a strap, a wire, a clasp, a clamp, and an adhesive (e.g., tape, glue), but is not limited thereto.

The conduit connecting surface 182 may be disposed on at least a portion of the connecting body 181. The conduit connecting surface 182 may removably connect the main body 110, the first laser emitter 120, and/or the second laser emitter 130 to the conduit 50. More specifically, the conduit connecting surface 182 may magnetically connect to the conduit 50. As such, the conduit connecting surface 182 may be used without use of tools and/or external fasteners. Accordingly, the conduit connecting surface 182 may provide a quick connection to the conduit 50 that saves time compared to using tools, straps, and/or clamps. Also, the conduit connecting surface 182 may use a magnetic connection to provide a stable and accurate measurement while connected to the conduit 50. As a result, the conduit connecting surface 182 may magnetically connect to the conduit 50 at any surface thereof, such that the main body 110 may be oriented on top, sideways, and/or upside down (e.g., the display unit 150 would be facing toward a ground surface in this position).

Furthermore, the conduit connecting surface 182 may have a concave surface that corresponds to a convex surface of the conduit 50. In other words, a shape of the conduit connecting surface 182 may correspond to a shape of the conduit 50, such that the conduit connecting surface 182 may receive the conduit 50 therein. Also, the conduit attachment unit 180 may be replaced with a conduit attachment unit 280 and/or a conduit attachment unit 380 based on the size of the conduit 50. For example, the conduit attachment unit 180 may be used on the conduit 50 having a one inch diameter, whereas the conduit attachment unit 380 may be used on another conduit 50 having a four inch diameter.

The conduit attachment unit 180 may alternatively include straps, clamps, adhesives, or any other type of attachment device to allow the position determination device 100 to be attached to the conduit 50 in any manner.

It is important to note that the first laser emitter 120 and/or the second laser emitter 130 may detect a reflection of the first laser beam 20 and/or the second laser beam 30, respectively, to determine the conduit installation information. Alternatively, the first laser emitter 120 and/or the second laser emitter 130 may use other methods for determining distance, such as triangulation, time-of-flight (e.g., pulse measurement for time of travel for a laser to reach a target), phase shift (e.g., laser intensity modulation), and/or frequency modulation (e.g., measuring distance based on frequency offset of a laser beam).

The conduit attachment unit 280 may include a connecting body 281, a conduit connecting surface 282, a first connecting ridge 283, and a second connecting ridge 284, but is not limited thereto.

The connecting body 281 may be removably connected to at least a portion of the main body 110. Moreover, the connecting body 281 may be connected to the main body 110 without using tools and/or external fasteners (e.g., screw, nail, bolt, washer, nut, etc.). For example, referring to FIG. 4, the connecting body 281 may have connect to the groove 113, such that the first connecting ridge 283 may be inserted into the first connecting edge 114, and the second connecting ridge 284 may be inserted into the second connecting edge 115. In other words, the groove 113 may receive the connecting body 281 therein.

The connecting body 281 and/or the conduit connecting surface 282 may include a magnet, a rope, a strap, a wire, a clasp, a clamp, and an adhesive (e.g., tape, glue), but is not limited thereto.

The conduit connecting surface 282 may be disposed on at least a portion of the connecting body 281. The conduit connecting surface 282 may removably connect the main body 110, the first laser emitter 120, and/or the second laser emitter 130 to the conduit 50. More specifically, the conduit connecting surface 282 may magnetically connect to the conduit 50. As such, the conduit connecting surface 282 may be used without use of tools and/or external fasteners. Accordingly, the conduit connecting surface 282 may provide a quick connection to the conduit 50 that saves time compared to using tools, straps, and/or clamps. Also, the conduit connecting surface 282 may use a magnetic connection to provide a stable and accurate measurement while connected to the conduit 50. As a result, the conduit connecting surface 282 may magnetically connect to the conduit 50 at any surface thereof, such that the main body 110 may be oriented on top, sideways, and/or upside down (e.g., the display unit 150 would be facing toward a ground surface in this position).

Furthermore, the conduit connecting surface 282 may have a concave surface that corresponds to a convex surface of the conduit 50. In other words, a shape of the conduit connecting surface 282 may correspond to a shape of the conduit 50, such that the conduit connecting surface 282 may receive the conduit 50 therein. Also, the conduit attachment unit 280 may be replaced with the conduit attachment unit 180 and/or the conduit attachment unit 380 based on the size of the conduit 50.

The conduit attachment unit 380 may include a connecting body 381, a conduit connecting surface 382, a first connecting ridge 383, and a second connecting ridge 384, but is not limited thereto.

The connecting body 381 may be removably connected to at least a portion of the main body 110. Moreover, the connecting body 381 may be connected to the main body 110 without using tools and/or external fasteners (e.g., screw, nail, bolt, washer, nut, etc.). For example, referring to FIG. 4, the connecting body 381 may have connect to the groove 113, such that the first connecting ridge 383 may be inserted into the first connecting edge 114, and the second connecting ridge 384 may be inserted into the second connecting edge 115. In other words, the groove 113 may receive the connecting body 381 therein.

The connecting body 381 and/or the conduit connecting surface 382 may include a magnet, a rope, a strap, a wire, a clasp, a clamp, and an adhesive (e.g., tape, glue), but is not limited thereto.

The conduit connecting surface 382 may be disposed on at least a portion of the connecting body 381. The conduit connecting surface 382 may removably connect the main body 110, the first laser emitter 120, and/or the second laser emitter 130 to the conduit 50. More specifically, the conduit connecting surface 382 may magnetically connect to the conduit 50. As such, the conduit connecting surface 382 may be used without use of tools and/or external fasteners. Accordingly, the conduit connecting surface 382 may provide a quick connection to the conduit 50 that saves time compared to using tools, straps, and/or clamps. Also, the conduit connecting surface 382 may use a magnetic connection to provide a stable and accurate measurement while connected to the conduit 50. As a result, the conduit connecting surface 382 may magnetically connect to the conduit 50 at any surface thereof, such that the main body 110 may be oriented on top, sideways, and/or upside down (e.g., the display unit 150 would be facing toward a ground surface in this position).

Furthermore, the conduit connecting surface 382 may have a concave surface that corresponds to a convex surface of the conduit 50. In other words, a shape of the conduit connecting surface 382 may correspond to a shape of the conduit 50, such that the conduit connecting surface 382 may receive the conduit 50 therein. Also, the conduit attachment unit 380 may be replaced with the conduit attachment unit 180 and/or the conduit attachment unit 280 based on the size of the conduit 50.

FIG. 5B illustrates an isometric side view of the position determination device 100 as disposed on a bottom portion of a conduit 50, according to an exemplary embodiment of the present general inventive concept.

Referring to FIG. 5B, similarly as FIG. 5B, the first laser emitter 120 may emit the first laser beam 20 as crosshairs. In other words, the first laser emitter 120 may emit a horizontal beam 21 from the first portion 121 and/or a vertical beam 22 from the second portion 122. Also, as described above, the second laser emitter 130 may emit the second laser beam 30 at the same point as the first laser beam 20 (e.g., at the intersection of the first portion 121 and/or the second portion 122 a.k.a. the crosshairs) and/or at a different angle with respect to the first laser emitter 120 toward the surface of the wall 10.

The first laser emitter 120 may also emit a laser beam 23 towards a ceiling or a floor 11 as well.

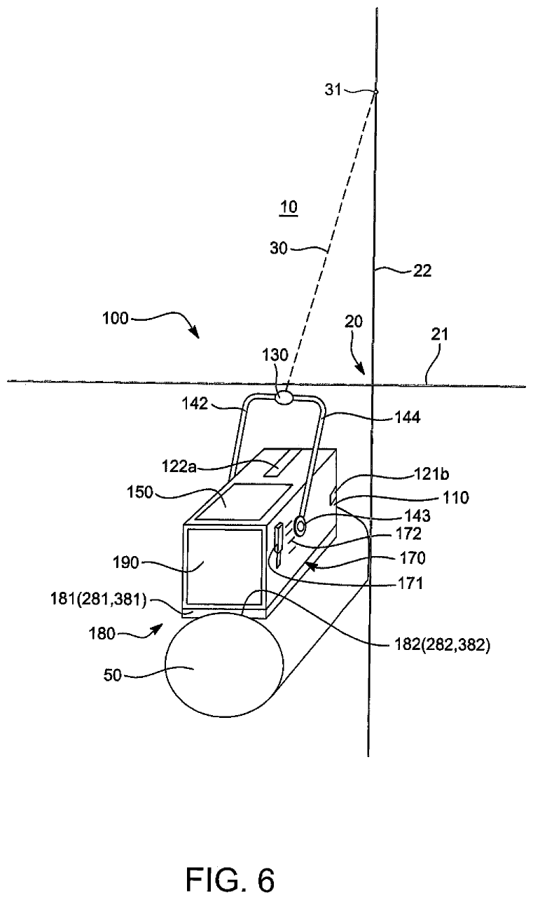

FIG. 6 illustrates an isometric top view of the position determination device 100 as disposed on the conduit 50, according to an exemplary embodiment of the present general inventive concept.

Referring to FIG. 6, the first laser emitter 120 may emit the first laser beam 20 as crosshairs. In other words, the first laser emitter 120 may emit a horizontal beam 21 from the first portion 121 and/or a vertical beam 22 from the second portion 122. Also, as described above, the second laser emitter 130 may emit the second laser beam 30 at the same point as the first laser beam 20 (e.g., at the intersection of the first portion 121 and/or the second portion 122 a.k.a. the crosshairs) and/or at a different angle with respect to the first laser emitter 120 toward the surface of the wall 10.

The battery compartment 190 may include a door and a battery, but is not limited thereto. The battery may also include button cells, coin batteries, alkaline, lithium-ion, nickel cadmium, nickel metal hydride, but is not limited thereto.

The battery compartment 190 may be disposed on and/or within at least a portion of the main body 110. The battery of the battery compartment 190 may be enclosed using the door. Moreover, the battery of the battery compartment 190 may power each component disposed on and/or within the main body 110.

Therefore, the position determination device 100 may easily connect to a surface of the conduit 50 to provide measurements for the conduit installation information.

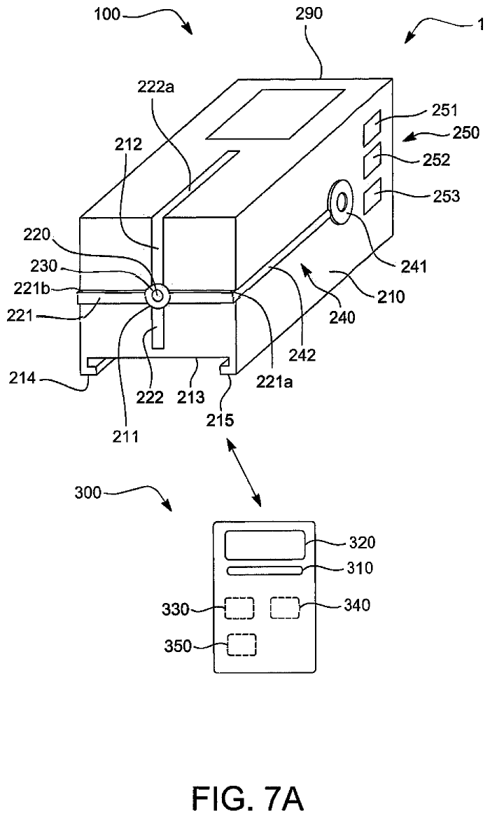

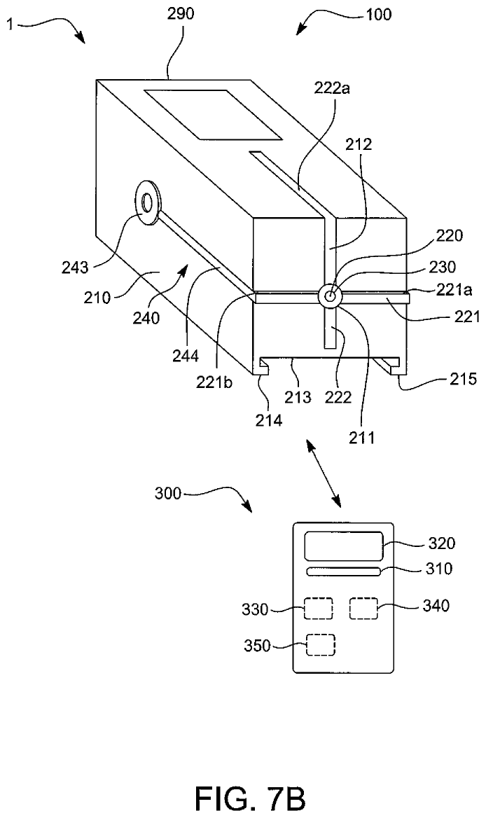

FIG. 7A illustrates a rear perspective view of a system 1 to determine angle and distance for conduit installation, according to another exemplary embodiment of the present general inventive concept.

FIG. 7B illustrates a side perspective view of the system 1 to determine angle and distance for conduit installation, according to another exemplary embodiment of the present general inventive concept.

The system 1 may be constructed from at least one of metal, plastic, wood, glass, and rubber, etc., but is not limited thereto.

The system 1 may include a position determination device 200 and a mobile device 300, but is not limited thereto.

The position determination device 200 may operate similar to the position determination device 100 and has similar components except for having a display unit disposed thereon.

Referring to FIGS. 7A and 7B, the position determination device 200 may include a main body 210, a first laser emitter 220, a second laser emitter 230, a hinge assembly 240, an input unit 250, a conduit attachment unit 180, and a battery compartment 290, but is not limited thereto.

Referring again to FIGS. 7A and 7B, the main body 210 is illustrated to have a rectangular prism shape. However, the main body 210 may be rectangular, circular, spherical, conical, triangular, pentagonal, hexagonal, heptagonal, octagonal, or any other shape known to one of ordinary skill in the art, but is not limited thereto.

The main body 210 may include a cross section 211, a laser channel 212, a groove 213, a first connecting edge 214, and a second connecting edge 215, but is not limited thereto.

The cross section 211 may be disposed on at least a portion of a center of a first side of the main body 210.

Referring again to FIGS. 7A and 7B, the laser channel 212 may be longitudinally disposed away from the cross section 211 with respect to the cross section 211. Moreover, the laser channel 212 may extend along at least a portion of the first side and/or a second side of the main body 210, such that the second side of the main body 211 may be perpendicularly disposed away from a first edge of the first side with respect to a direction.

The groove 213 may be longitudinally disposed on at least a portion of a third side of the main body 210, such that the third side of the main body 210 may be perpendicularly disposed away from a second edge of the first side of the main body 210 with respect to the direction. As such, the second side of the main body 210 may be parallel to the third side. Also, the groove 213 may extend a full length of the third side of the main body 210.

The first connecting edge 214 may be disposed on at least a portion of the third side of the main body 210. Additionally, the first connecting edge 214 may extend and/or protrude away from the third side of the main body 210 in an L-shape and/or a hook shape toward a center of the groove 213.

The second connecting edge 215 may be disposed on at least a portion of the third side of the main body 210. Additionally, the second connecting edge 215 may extend and/or protrude away from the third side of the main body 210 in an L-shape and/or a hook shape toward the center of the groove 213. Accordingly, the second connecting edge 215 may point toward the first connecting edge 214 and vice versa.

The first laser emitter 220 may include a first portion 221 and a second portion 222, but is not limited thereto.

The first laser emitter 220 may be a line laser, a spot laser, a combination laser, a rotary laser, and a laser detector, but is not limited thereto.

The first laser emitter 220 may be disposed on at least a portion of the cross section 211 of the main body 210. The first laser emitter 220 may emit a first laser beam 20 toward a surface of a wall 10. Moreover, the first laser emitter 220 may emit the first laser beam 20 as a first line and/or a first point on the wall 10. The first laser emitter 220 may remain in a fixed position with respect to the main body 210.

Furthermore, the first laser emitter 220 may be crosshairs formed by an intersection of the first portion 221 and/or the second portion 222. Referring again to FIGS. 7A and 7B, the first portion 221 may be longitudinally disposed along the center of the first side of the main body 210. The second portion 222 may be perpendicularly disposed at the center of the first side of the main body 210 with respect to a direction. Accordingly, the first portion 221 and/or the second portion 222 may form the crosshairs.

The first portion 221 may include a first angled end 221a and a second angled end 221b, but is not limited thereto.

The first angled end 221a may be disposed on at least a portion of a fourth side of the main body 210. Moreover, the first angled end 221a may be perpendicularly disposed away from a remainder of the first portion 221 disposed on the first side of the main body 210 with respect to a first direction. As such, the first angled end 221a may allow the first laser emitter 220 to emit the first laser beam 20 on the wall 10 and a first other surface angularly disposed away from the wall 10, such that the first other surface is disposed a distance away from the first laser emitter 220.

Similarly, the second angled end 221b may be disposed on at least a portion of a fifth side of the main body 210 opposite with respect to the fourth side. Moreover, the second angled end 221b may be perpendicularly disposed away from the remainder of the first portion 221 disposed on the first side of the main body 210 with respect to the first direction. As such, the second angled end 221b may allow the first laser emitter 220 to emit the first laser beam 20 on the wall 10 and/or a second other surface angularly disposed away from the wall 10, such that the second other surface is disposed another distance away from the first laser emitter 220.

The second portion 222 may include an angled end 222a, but is not limited thereto.

The angled end 222a may be disposed on at least a portion of a sixth side of the main body 210. Moreover, the angled end 222a may be perpendicularly disposed away from the remainder of the second portion 221 disposed on the first side of the main body 210 with respect to the first direction. As such, the angled end 222a may allow the first laser emitter 220 to emit the first laser beam 20 on the wall 10 and/or a third other surface angularly disposed away from the wall 10, such that the third other surface is disposed another distance away from the first laser emitter 220.

Accordingly, the first angled end 221a, the second angled end 221b, and/or the angled end 222a may allow the first laser emitter 220 to angularly (e.g., perpendicularly) emit the first laser beam 20 on different surfaces aside from the wall 10 directly in front of the first laser emitter 220. As such, for example, the first laser emitter 220 may emit the first laser beam 20 on the wall 10, a ceiling, and/or two side walls.

The second laser emitter 230 may include a line laser, a spot laser, a combination laser, a rotary laser, and a laser detector, but is not limited thereto.

The second laser emitter 230 may be hingedly disposed on at least a portion of the main body 210. More specifically, the second laser emitter 230 may move (i.e., pivot and/or rotate) from pointing in a first direction that is parallel with respect to the first laser emitter 220 to pointing at least partially toward at least one second direction different from the first direction. Conversely, the second laser emitter 230 may move from pointing in the at least one second direction to pointing in the first direction. As such, the second laser emitter 230 may originate by pointing at the first point, which is identical to the first laser emitter 220, and subsequently, move to another position, such that the second laser emitter 230 may be angularly disposed at a different angle with respect to the first laser emitter 220 and emit a second laser beam 30 toward the surface of the wall 10 as a second line and/or a second point 31 on the wall 10. Alternatively, the second point 31 may be referred to as a laser point 31. Accordingly, the laser point 31 may identify a target position for the conduit 50 and/or another conduit 50.

Additionally, the second laser beam 30 may be visible and/or invisible. In other words, a visibility of the second laser beam 30 may be adjusted based on a preference of a user, such as using the input unit 250. However, the laser point 31 may be visible on the wall 10 while the second laser beam 30 is invisible.

Furthermore, the second laser emitter 230 may move up to a second position at a ninety degree angle with respect to the first point.

Also, it is important to note that although the first laser emitter 220 is described as being fixed, the first laser emitter 220 may be hingedly disposed on the main body 210 similar to the second laser emitter 230. As such, the first laser emitter 220 may move to different positions similar to the second laser emitter 130 as described above.

The first laser emitter 220 may emit the first laser beam 20 as crosshairs. In other words, the first laser emitter 220 may emit a horizontal beam 21 from the first portion 221 and/or a vertical beam 22 from the second portion 222. Also, as described above, the second laser emitter 230 may emit the second laser beam 30 at the same point as the first laser beam 20 (e.g., at the intersection of the first portion 221 and/or the second portion 222 a.k.a. the crosshairs) and/or at a different angle with respect to the first laser emitter 220 toward the surface of the wall 10.

The hinge assembly 240 may include a first hinge 241, a first arm 242, a second hinge 243, and a second arm 243, but is not limited thereto.

The first hinge 241 may be disposed on at least a portion of a fourth side of the main body 210.

The first arm 242 may be disposed on at least a portion of the first hinge 241 and connected to the second laser emitter 230.

The second hinge 243 may be disposed on at least a portion of a fifth side of the main body 210 opposite with respect to the fourth side.

The second arm 243 may be disposed on at least a portion of the second hinge 243 and connected to the second laser emitter 230. As such, the second laser emitter 130 may move in response to movement of the first hinge 241, the first arm 242, the second hinge 243, and/or the second arm 243. It is important to note that the first hinge 241, the first arm 242, the second hinge 243, and/or the second arm 243 may move simultaneously. Also, the first arm 242 and/or the second arm 243 may project the second laser emitter 230 a distance away from any surface of the main body 210.

The input unit 250 may include a first laser emitter button 251, a second laser emitter button 252, and a power button 253, but is not limited thereto.

Furthermore, the input unit 250 may include a communication module, such as a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The input unit 250 may be disposed on at least a portion of the fourth side of the main body 210.

Referring again to FIGS. 7A and 7B, the first laser emitter button 251, the second laser emitter button 252, and/or the power button 253 are each illustrated to be a button. However, the first laser emitter button 251, the second laser emitter button 252, and/or the power button 253 may be a switch, a lever, a knob, and/or a dial, but is not limited thereto.

The first laser emitter 220 may turn on the first laser beam 20 in response to depressing the first laser emitter button 251 a first time. Conversely, the first laser emitter 220 may turn off the first laser beam 20 in response to depressing the first laser emitter button 251 a second time.

The second laser emitter 230 may turn on the second laser beam 30 in response to depressing the second laser emitter button 252 a first time. Conversely, the second laser emitter 230 may turn off the second laser beam 30 in response to depressing the second laser emitter button 252 a second time. Furthermore, the second laser emitter 230 may move in response to depressing the second laser emitter button 252 for at least one predetermined period of time. For example, the second laser emitter 230 may move to a first predetermined position (e.g., the original position) in response to depressing the second laser emitter button 252 for five seconds, move to a second predetermined position (e.g., ten degrees away from the original position and/or the first laser emitter 220 position) in response to depressing the second laser emitter button 252 for ten seconds, and move to a third predetermined position (e.g., ninety degrees away from the original position and/or the first laser emitter position 220 as in FIG. 2) in response to depressing the second laser emitter button 252 for fifteen seconds. Also, the second laser emitter 230 may move anywhere in between the aforementioned positions after stopping depressing the second laser emitter button 230 in between movement.

The first laser emitter 220 and/or the second laser emitter 230 may turn on in response to depressing the power button 253 a first time. Conversely, the first laser emitter 220 and/or the second laser emitter 230 may turn off in response to depressing the power button 253 a second time.

The processing unit 255 (or central processing unit, CPU) may include electronic circuitry to carry out instructions of a computer program by performing basic arithmetic, logical, control and input/output (I/O) operations specified by the instructions. The processing unit 255 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 255 may also include a microprocessor and a microcontroller.

The processing unit 255 may further include a storage unit (e.g., a random access memory (RAM), a read-only memory (ROM), a hard disk, a flash drive, a database connected to the Internet, cloud-based storage, Internet-based storage, or any other type of storage unit), but is not limited thereto.

The processing unit 255 may be disposed within at least a portion of the main body 210. The processing unit 255 may run a software application and/or a mobile application. For ease of description, the mobile and/or the software application will be hereinafter referred to as a calculation app. The processing unit 255 executing the calculation app may calculate the size of pipe based on the position of the first laser beam 20 and/or the second laser beam 30, the angle at which the conduit 50 and/or the another conduit 50 needs to be positioned with respect to the conduit 50, the distance of the first laser emitter 220 to the wall 10, and/or the distance of the second laser emitter 230 to the wall 10. Moreover, the processing unit 255 executing the calculation app may analyze the distance and/or the angle based on mathematical formulas. For example, the processing unit 255 may analyze a triangular shape and/or angle based on at least one position of the first laser emitter 220 and/or the second laser emitter 230 using the law of sines, the law of cosines, Pythagorean theorem, sines, cosines, tangents, secants, and/or cosecants.

The conduit attachment unit 180, the conduit attachment unit 280, and/or the conduit attachment unit 380 may be connected to the main body 210 similar to connecting to the main body 110 as described above.

The battery compartment 290 may include a door and a battery, but is not limited thereto. The battery may also include button cells, coin batteries, alkaline, lithium-ion, nickel cadmium, nickel metal hydride, but is not limited thereto.

The battery compartment 290 may be disposed on and/or within at least a portion of the main body 210. The battery of the battery compartment 290 may be enclosed using the door. Moreover, the battery of the battery compartment 290 may power each component disposed on and/or within the main body 210.

The mobile device 300 may be described as a mobile device. For example, the mobile device 300 may be a smartphone, a cellphone, a smartwatch, a tablet, a personal digital assistant (PDA), a laptop computer, and an electronic reader, but is not limited thereto.

The mobile device 300 may include an input unit 310, a display unit 320, a processing unit 330, a communication unit 340, and a storage unit 350, but is not limited thereto.

The input unit 310 may include a keyboard, a touchpad, a mouse, a trackball, a stylus, a voice recognition unit, a visual data reader, a camera, a wireless device reader, and a holographic input unit.

The display unit 320 may include a plasma screen, an LCD screen, a light emitting diode (LED) screen, an organic LED (OLED) screen, a computer monitor, a hologram output unit, a sound outputting unit, or any other type of device that visually or aurally displays data.

Also, the display unit 320 may be combined with the input unit 310 to be a touch-screen.

The processing unit 330 (or central processing unit, CPU) may include electronic circuitry to carry out instructions of a computer program by performing basic arithmetic, logical, control and input/output (I/O) operations specified by the instructions. The processing unit 330 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 330 may also include a microprocessor and a microcontroller.

The communication unit 340 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 350 may include a random access memory (RAM), a read-only memory (ROM), a hard disk, a flash drive, a database connected to the Internet, cloud-based storage, Internet-based storage, or any other type of storage unit.

The mobile device 300 may access the Internet via the communication unit 340 to allow a user to access a website, and/or may allow a mobile and/or a software application to be executed using the processing unit 330. For ease of description, the mobile and/or the software application will be hereinafter referred to as an app. The app may be downloaded from the Internet to be stored on the storage unit 350.

The processing unit 330 executing the app may generate on the display unit 320 the digital readout of the at least one number corresponding to conduit installation information. More specifically, the display unit 320 may display the digital readout corresponding to the size of the conduit 50 based on the position of the first laser beam 20 and/or the second laser beam 30, the angle at which the conduit 50 and/or the another conduit 50 needs to be positioned with respect to the conduit 50, the distance of the first laser emitter 220 to the wall 10, and/or the distance of the second laser emitter 230 to the wall 10. As such, the display unit 320 may display the conduit installation information to facilitate installation of the conduit 50. Moreover, the input unit 310 may receive input to send an input command from the communication unit 340 to the communication module of the input unit 250. As such, the input unit 310 may control the first laser emitter 220, and/or the second laser emitter 230 in a similar manner as described above with respect to the input unit 250.

Furthermore, the display unit 320 may display one of the conduit installation information and/or all of the conduit installation information simultaneously, as described above, based on manipulation of the input unit 310.

For example, the input unit 310 may receive at least one input for a position of the second laser emitter 230, such that the second laser emitter 230 may move from pointing in the first direction to pointing at least partially toward the at least one second direction in response to the input unit 310 receiving a first position input, and the second laser emitter 230 may move from pointing in the at least one second direction to pointing in the first direction in response to the input unit 310 receiving a second position input.

Also, the storage unit 350 may store at least one predetermined setting, such that the processing unit 330 executing the app may automatically move the second laser emitter 230 based on the at least one predetermined setting and/or the conduit installation information.

Therefore, the system 1 may facilitate conduit installation by determining angle and distance of the conduit 50. Also, the position determination device 200 may easily connect to a surface of the conduit 50 to provide measurements for the conduit installation information.

The system 1, the position determination device 100, the position determination device 200, and/or the mobile device 300 may be performed using a computer readable medium and/or software comprising instructions for performing the functions and/or steps described above.

The present general inventive concept may include a position determination device 100, including a main body 110, a first laser emitter 120 disposed on at least a portion of the main body 110 to emit a first laser beam 20 pointing in a first direction, a second laser emitter 130 hingedly disposed on at least a portion of the main body 110 to emit a second laser beam 30 pointing in the first direction, such that the first laser emitter 120 and the second laser emitter 130 determine at least one of a size of a conduit 50, an angle to install the conduit 50, a distance of the first laser emitter 120 to a wall 10, and a distance of the second laser emitter 130 to the wall 10, and a conduit attachment unit 180 removably connected to at least a portion of the main body 110 to connect the main body 110 to the conduit 50.

The first laser emitter 120 may be fixed pointing in the first direction.

The second laser emitter 130 may move from pointing in the first direction to pointing at least partially toward a second direction different from the first direction, and move from pointing in the second direction to pointing in the first direction.

The second laser emitter 130 may emit the second laser beam 30 on a same point as the first laser emitter 120 while the second laser emitter 130 is pointing in the first direction.

The conduit attachment unit 180 may include a connecting body 181, a conduit connecting surface 182 disposed on at least a portion of the connecting body 181 to removably connect the main body 110 to the conduit 50, a first connecting ridge 183 disposed on at least a portion of the connecting body 181 to removably connect to at least a portion of the main body 110, and a second connecting ridge 184 disposed on at least a portion of the connecting body 181 to removably connect to at least a portion of the main body 110.

The conduit fastener 142 may be magnetically connected to the conduit 50.

The conduit fastener 142 may have a concave surface that corresponds to a convex surface of the conduit 50.

The main body 110 may include a groove 113 longitudinally disposed on at least a portion of the main body 110 to receive the connecting body 181 therein, a first connecting edge 114 disposed on at least a portion of the main body 110 to connect to the first connecting ridge 183, and a second connecting edge 115 disposed on at least a portion of the main body 110 to connect to the second connecting ridge 184.

The position determination device 100 may further include a display unit 150 disposed on at least a portion of the main body 110 to display a digital readout of at least one number corresponding to at least one of the size of the conduit 50, the angle to install the conduit 50, the distance of the first laser emitter 120 to the wall 10, and the distance of the second laser emitter 130 to the wall 10.

The position determination device 100 may further include an input unit 160 disposed on at least a portion of the main body 110 to move the second laser emitter 130 from pointing in the first direction to pointing at least partially toward a second direction in response to the input unit 160 receiving a first position input, and move the second laser emitter 130 from pointing in the second direction to pointing in the first direction in response to the input unit 160 receiving a second position input.

The present general inventive concept may also include a system 1 to determine an angle and distance for installation of a conduit 50, the system 1 including a position determination device 200 removably connected to the conduit 50 to emit a first laser beam 20 pointing in a first direction and a second laser beam 30 pointing in the first direction, and a mobile device 300 running a program thereon and connected to the position determination device 200 to move the second laser beam 30 from pointing in the first direction to pointing at least partially toward a second direction different from the first direction, and display a digital readout of at least one number corresponding to at least one of a size of the conduit 50 based on the position of the first laser beam 20 and the second laser beam 30, an angle at which the conduit 50 needs to be positioned, a distance of the first laser beam to a wall 10, and a distance of the second laser beam 30 to the wall 10.

The position determination device 200 may include a main body 210, a first laser emitter 220 disposed on at least a portion of the main body 210 to emit a first laser beam pointing in the first direction, and a second laser emitter 230 hingedly disposed on at least a portion of the main body 210 to emit a second laser beam pointing in the first direction.

The second laser emitter 230 may move from pointing in the first direction to pointing at least partially toward the second direction in response to the mobile device 300 receiving a first position input, and move from pointing in the second direction to pointing in the first direction in response to the mobile device 300 receiving a second position input.

The mobile device 300 may automatically move the second laser beam 30 based on at least one of the size of the conduit 50 based on the position of the first laser beam 20 and the second laser beam 30, the angle to install the conduit 50, the distance of the first laser beam 20 to the wall 10, and the distance of the second laser beam 30 to the wall 10.

The foregoing and/or other features and utilities of the present general inventive concept may also be achieved by providing a position determination device 110, including a main body 110, a first light emitter 120 disposed on the main body 110 to emit a first beam of light 20 in at least a first direction, a second light emitter 130 moveably disposed on the main body to emit a second beam of light 30 in at least the first direction, and a processor 155 to perform a calculation based on information received from at least one of the first light emitter 120 and the second light emitter 130 to output a numeric value corresponding to at least one of a size of a conduit 50, an angle required to install the conduit, a distance of the first laser emitter 120 to a wall 10, a distance of the second laser emitter 130 to the wall 10, and an angle between the first laser beam 20 and the second laser beam 30.

The position determination device 110 may further include a display unit 150 to display the output calculated by the processor 155.

The position determination device 100 may further include a conduit attachment unit 180 removably connected to at least a portion of the main body 110 to connect the main body 110 to the conduit 50.

As will be appreciated by a person of ordinary skill in the art, aspects of the present general inventive concept may be embodied as a method, a device, a system, or a computer program product, for example. Accordingly, aspects of the present general inventive concept may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present general inventive concept may take the form of a computer program product embodied in one or more computer-readable data storage devices or computer-readable data storage components that include computer-readable medium(s) having computer readable program code embodied thereon. For example, a computer-readable data storage device may be embodied as a tangible device that may include a tangible data storage medium (which may be non-transitory in some examples), as well as a controller configured for receiving instructions from a resource such as a central processing unit (CPU) to retrieve information stored at one or more particular addresses in the tangible, non-transitory data storage medium, and for retrieving and providing the information stored at those particular one or more addresses in the data storage medium.

The data storage device may store information that encodes both instructions and data, for example, and may retrieve and communicate information encoding instructions and/or data to other resources such as a CPU, for example. The data storage device may take the form of a main memory component such as a hard disc drive or a flash drive in various embodiments, for example. The data storage device may also take the form of another memory component such as a RAM integrated circuit or a buffer or a local cache in any of a variety of forms, in various embodiments. This may include a cache integrated with a controller, a cache integrated with a graphics processing unit (GPU), a cache integrated with a system bus, a cache integrated with a multi-chip die, a cache integrated within a CPU, or the processor registers within a CPU, as various illustrative examples. The data storage apparatus or data storage system may also take a distributed form such as a redundant array of independent discs (RAID) system or a cloud-based data storage service, and still be considered to be a data storage component or data storage system as a part of or a component of an embodiment of a system of the present general inventive concept, in various embodiments.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, electro-optic, heat-assisted magnetic, or semiconductor system, apparatus, or device, or any suitable combination of the foregoing. A non-exhaustive list of additional specific examples of a computer readable storage medium includes the following: an electrical connection having one or more wires, a portable computer diskette, a hard disc, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device, for example.

Program code embodied on a computer readable medium may be transmitted using any appropriate medium, including but not limited to radio frequency (RF) or other wireless, wire line, optical fiber cable, etc., or any suitable combination of the foregoing. Computer program code for carrying out operations for aspects of the present general inventive concept may be written in any combination of one or more programming languages, including an object oriented programming language such as Java, Smalltalk, C++, or the like, or other imperative programming languages such as C, or functional languages such as Common Lisp, Haskell, or Clojure, or multi-paradigm languages such as C#, Python, or Ruby, among a variety of illustrative examples. One or more sets of applicable program code may execute partly or entirely on the user's desktop or laptop computer, smartphone, tablet, or other computing device; as a stand-alone software package, partly on the user's computing device and partly on a remote computing device; or entirely on one or more remote servers or other computing devices, among various examples. In the latter scenario, the remote computing device may be connected to the user's computing device through any type of network, including a local area network (LAN) or a wide area network (WAN), or the connection may be made to an external computer (for example, through a public network such as the Internet using an Internet Service Provider), and for which a virtual private network (VPN) may also optionally be used.

In various illustrative embodiments, various computer programs, software applications, modules, or other software elements may be executed in connection with one or more user interfaces being executed on a client computing device, that may also interact with one or more web server applications that may be running on one or more servers or other separate computing devices and may be executing or accessing other computer programs, software applications, modules, databases, data stores, or other software elements or data structures. A graphical user interface may be executed on a client computing device and may access applications from the one or more web server applications, for example. Various content within a browser or dedicated application graphical user interface may be rendered or executed in or in association with the web browser using any combination of any release version of HTML, CSS, JavaScript, XML, AJAX, JSON, and various other languages or technologies. Other content may be provided by computer programs, software applications, modules, or other elements executed on the one or more web servers and written in any programming language and/or using or accessing any computer programs, software elements, data structures, or technologies, in various illustrative embodiments.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Aspects of the present general inventive concept are described herein with reference to flowchart illustrations and/or block diagrams of methods, apparatus, systems, and computer program products according to embodiments of the general inventive concept. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, may create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices, to produce a computer-implemented process such that the instructions that execute on the computer or other programmable apparatus provide or embody processes for implementing the functions or acts specified in the flowchart and/or block diagram block or blocks.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A position determination device, comprising:
a main body;
a first laser emitter disposed on at least a portion of the main body to emit a first laser beam pointing in a first direction;
a second laser emitter hingedly disposed on at least a portion of the main body to emit a second laser beam pointing in the first direction, such that at least one of the first laser emitter and the second laser emitter is used to determine at least one of a size of a required conduit, an angle required to install the conduit, a distance of the first laser emitter to a wall, a distance of the second laser emitter to the wall, and an angle between the first laser beam and the second laser beam; and
a conduit attachment unit removably connected to at least a portion of the main body to connect the main body to the conduit.

2. The position determination device of claim 1, wherein the first laser emitter is fixed pointing in the first direction.

3. The position determination device of claim 1, wherein the second laser emitter moves from pointing in the first direction to pointing at least partially toward a second direction different from the first direction, and moves from pointing in the second direction to pointing in the first direction.

4. The position determination device of claim 1, wherein the second laser emitter emits the second laser beam on a same point as the first laser emitter while the second laser emitter is pointing in the first direction.

5. The position determination device of claim 1, wherein the conduit attachment unit comprises:
a connecting body;
a conduit connecting surface disposed on at least a portion of the connecting body to removably connect the main body to the conduit;
a first connecting ridge disposed on at least a portion of the connecting body to removably connect to at least a portion of the main body; and
a second connecting ridge disposed on at least a portion of the connecting body to removably connect to at least a portion of the main body.

6. The position determination device of claim 5, wherein the conduit connecting surface is magnetically connected to the conduit.

7. The position determination device of claim 5, wherein the conduit connecting surface has a concave surface that corresponds to a convex surface of the conduit.

8. The position determination device of claim 5, wherein the main body comprises:
a groove longitudinally disposed on at least a portion of the main body to receive the connecting body therein;
a first connecting edge disposed on at least a portion of the main body to connect to the first connecting ridge; and
a second connecting edge disposed on at least a portion of the main body to connect to the second connecting ridge.

9. The position determination device of claim 1, further comprising:
a display unit disposed on at least a portion of the main body to display a digital readout of at least one number corresponding to at least one of the size of the conduit, the angle to install the conduit, the distance of the first laser emitter to the wall, and the distance of the second laser emitter to the wall.

10. The position determination device of claim 1, further comprising:
an input unit disposed on at least a portion of the main body to move the second laser emitter from pointing in the first direction to pointing at least partially toward a second direction in response to the input unit receiving a first position input, and move the second laser emitter from pointing in the second direction to pointing in the first direction in response to the input unit receiving a second position input.

11. A system to determine an angle and distance for installation of a conduit, the system comprising:
a position determination device removably connected to the conduit to emit a first laser beam pointing in a first direction and a second laser beam pointing in the first direction; and
a mobile device running a program thereon and connected to the position determination device to move the second laser beam from pointing in the first direction to pointing at least partially toward a second direction different from the first direction, and display a digital readout of at least one number corresponding to at least one of a size of the conduit based on the position of the first laser beam and the second laser beam, an angle at which the conduit needs to be positioned, a distance of the first laser beam to a wall, and a distance of the second laser beam to the wall.

12. The system of claim 11, wherein the position determination device comprises:
a main body;
a first laser emitter disposed on at least a portion of the main body to emit a first laser beam pointing in the first direction; and
a second laser emitter hingedly disposed on at least a portion of the main body to emit a second laser beam pointing in the first direction.

13. The system of claim 12, wherein the second laser emitter moves from pointing in the first direction to pointing at least partially toward the second direction in response to the mobile device receiving a first position input, and moves from pointing in the second direction to pointing in the first direction in response to the mobile device receiving a second position input.

14. The system of claim 11, wherein the mobile device automatically moves the second laser beam based on at least one of the size of the conduit based on the position of the first laser beam and the second laser beam, the angle to install the conduit, the distance of the first laser beam to a wall, and the distance of the second laser beam to the wall.

15. A position determination device, comprising:
a main body;
a first light emitter disposed on the main body to emit a first beam of light in at least a first direction;
a second light emitter moveably disposed on the main body to emit a second beam of light in at least the first direction; and
a processor to perform a calculation based on information received from at least one of the first light emitter and the second light emitter to output a numeric value corresponding to at least one of a size of a conduit, an angle required to install the conduit, a distance of the first laser emitter to a wall, a distance of the second laser emitter to the wall, and an angle between the first laser beam and the second laser beam.

16. The position determination device of claim 15, further comprising:
a display unit to display the output calculated by the processor.

17. The position determination device of claim 15, further comprising:
a conduit attachment unit removably connected to at least a portion of the main body to connect the main body to the conduit.
